(19) United States
(12) Patent Application Publication
(10) Pub. No.: US 2020/0262035 A1
(43) Pub. Date: Aug. 20, 2020

(54) OIL PULSE UNIT OF A PNEUMATIC TOOL

(71) Applicant: AIRBOSS AIR TOOLS CO., LTD., Taichung City (TW)

(72) Inventor: Hsin-He CHANG, Taichung City (TW)

(21) Appl. No.: 16/277,199

(22) Filed: Feb. 15, 2019

(51) Int. Cl. B25B 21/02; B25F 5/00; B25B 23/145; B25B 23/14

(52) U.S. Cl. CPC B25B 21/02; B25B 23/1405; B25B 23/1453; B25F 5/005

(57) ABSTRACT

An oil pulse unit has a cylinder, an output shaft, and a pressure-relief valve. The cylinder has a hydraulic oil chamber, a pressure-relief chamber and a communicating channel. The communicating channel is formed in the cylinder between the hydraulic oil chamber and the pressure-relief chamber, and communicates with the hydraulic oil chamber and the pressure-relief chamber. The output shaft is mounted with the cylinder and extends into the hydraulic oil chamber. The pressure-relief valve is mounted in the pressure-relief chamber and has a piston, a seal ring, an elastic element, and a retaining ring. The seal ring is sleeved on the piston, and abuts against the piston and the pressure-relief chamber. The elastic element has a first end and a second end. The elastic element abuts against the piston. The retaining ring is embedded in the pressure-relief chamber and abuts against the elastic element.

### BACKGROUND OF THE INVENTION

### 1. Field of the Invention

The present invention relates to a structure of a pneumatic tool propelled by pressure of fluid, and more particularly to an oil pulse unit of a pneumatic tool that can adjust the pressure of the hydraulic oil filled within, and can maintain the torque outputted.

### 2. Description of Related Art

A pneumatic tool is a power tool driven by compressed air. Users can assemble or disassemble elements labor-savingly and quickly by the pneumatic tools. Conventional pneumatic tools can be roughly divided into two kinds. The first kind of the conventional pneumatic tool comprises a rotor, an impact assembly, and an output shaft. The rotor is mounted in the conventional pneumatic tool and is driven to rotate by compressed air. The rotor propels the impact assembly. Then the impact assembly impacts the output shaft to fasten fixing elements.

With reference to FIGS. 8 and 9, the second kind of the conventional pneumatic tool comprises a rotor 70, an oil pulse unit 80, and an output shaft 90. The rotor 70 is also driven by compressed air. The rotor 70 propels the oil pulse unit 80. The oil pulse unit 80 is filled with hydraulic oil. The hydraulic oil transmits force by the pressure it exerts on the oil pulse unit 80. The output shaft 90 is then impacted by the hydraulic oil to fasten the fixing elements.

The conventional pneumatic tool that comprises an oil pulse unit 80 is popular because it works with low noise and small vibration. However, as shown in FIG. 10, as the operating time increases, the hydraulic oil flows within the oil pulse unit 80 repeatedly and therefore causes friction. The temperature rises and the volume of the hydraulic oil increases thereby, which causes the gradual decrease of the force transmitted from the hydraulic oil to the output shaft 90. In that case, the output shaft 90 cannot provide enough torque to fasten the fixing elements. Furthermore, when the temperature and the volume of the hydraulic oil reach the highest point under the circumstance mentioned above, the rotor 70 and the oil pulse unit 80 may rotate synchronically. Then the oil pulse unit 80 cannot propel the output shaft 90. The curve A in FIG. 10 represents the temperature and the pressure of the hydraulic oil, and the curve B in FIG. 10 represents the torque outputted by the pneumatic tool.

To overcome the shortcomings of the oil pulse unit 80 of the conventional pneumatic tool, the present invention tends to provide an oil pulse unit of a pneumatic tool to mitigate or obviate the aforementioned problems.

### SUMMARY OF THE INVENTION

The main objective of the present invention is to provide an oil pulse unit of a pneumatic tool that can adjust the pressure of the hydraulic oil filled within, and can maintain the torque outputted.

The oil pulse unit of a pneumatic tool in accordance with the present invention has a cylinder, an output shaft, and a pressure-relief valve. The cylinder has a first end, a second end, a hydraulic oil chamber, a pressure-relief chamber, and a communicating channel. The second end of the cylinder is opposite the first end of the cylinder. The hydraulic oil chamber is formed from the first end of the cylinder toward the second end of the cylinder. The pressure-relief chamber is formed from the second end of the cylinder toward the first end of the cylinder. The pressure-relief chamber does not communicate with the hydraulic oil chamber. The communicating channel is formed in the cylinder between the hydraulic oil chamber and the pressure-relief chamber, and communicates with the hydraulic oil chamber and the pressure-relief chamber. The output shaft is coaxially mounted with the cylinder, extends into the hydraulic oil chamber, and has a working end extending out of the first end of the cylinder. The pressure-relief valve is mounted in the pressure-relief chamber of the cylinder and has a piston, a seal ring, an elastic element, and a retaining ring. The piston has a first end and a second end, and the second end is opposite the first end of the piston. The first end of the piston faces the communicating channel of the cylinder. The seal ring is sleeved on the piston, and abuts against an outer surface of the piston and an inner surface of the pressure-relief chamber. The elastic element has a first end and a second end, and the second end is opposite the first end of the elastic element. The first end of the elastic element abuts against the second end of the piston. The retaining ring is embedded in the pressure-relief chamber and abuts against the elastic element.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of an oil pulse unit of a pneumatic tool in accordance with the present invention;

FIG. 2 is an exploded side view of the oil pulse unit of the pneumatic tool in FIG. 1;

FIG. 3 is an exploded perspective view of a pressure-relief valve of the oil pulse unit of the pneumatic tool in FIG. 1;

FIG. 4 is an enlarged side view in partial section of the oil pulse unit of the pneumatic tool in FIG. 1;

FIG. 5 is an operational side view in partial section of the oil pulse unit of the pneumatic tool in FIG. 4;

FIG. 6 is another operational side view in partial section of the oil pulse unit of the pneumatic tool in FIG. 4;

FIG. 7 is a diagram showing the torque outputted by the oil pulse unit of the pneumatic tool in FIG. 1;

FIG. 8 is a side view in partial section of a pneumatic tool in accordance with the prior art;

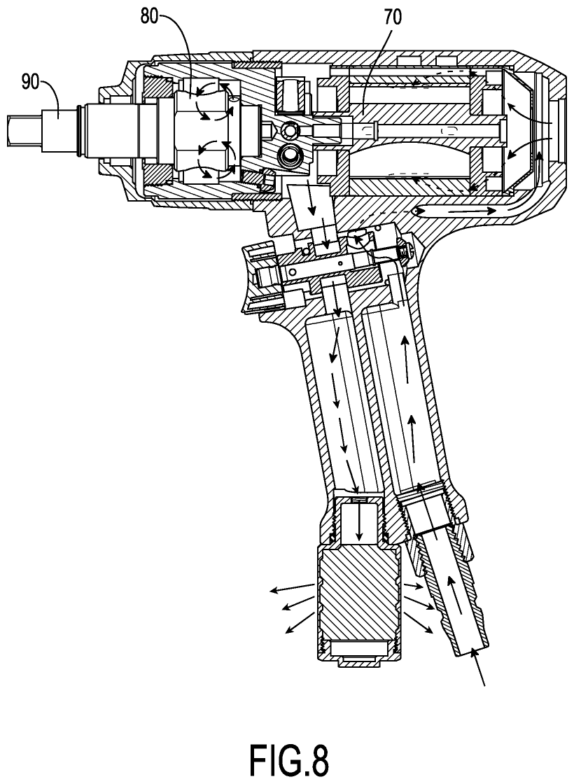

FIG. 9 is an enlarged side view in partial section of the pneumatic tool in FIG. 8; and

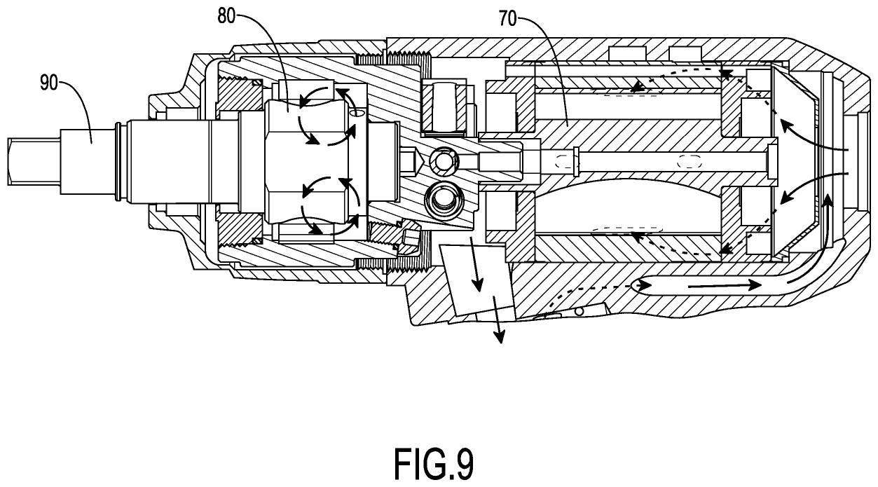

FIG. 10 is a diagram showing the torque outputted by the pneumatic tool in FIG. 8.

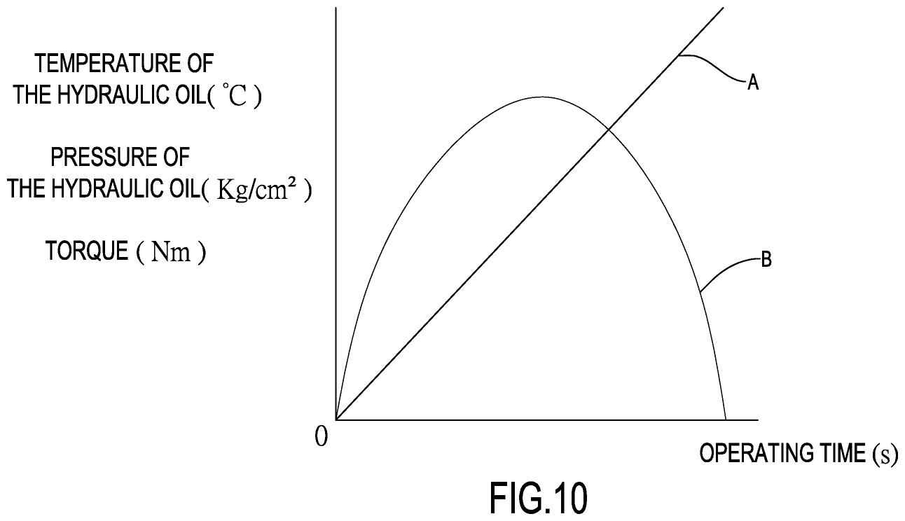

### DETAILED DESCRIPTION OF THE PREFERRED EMBODIMENT

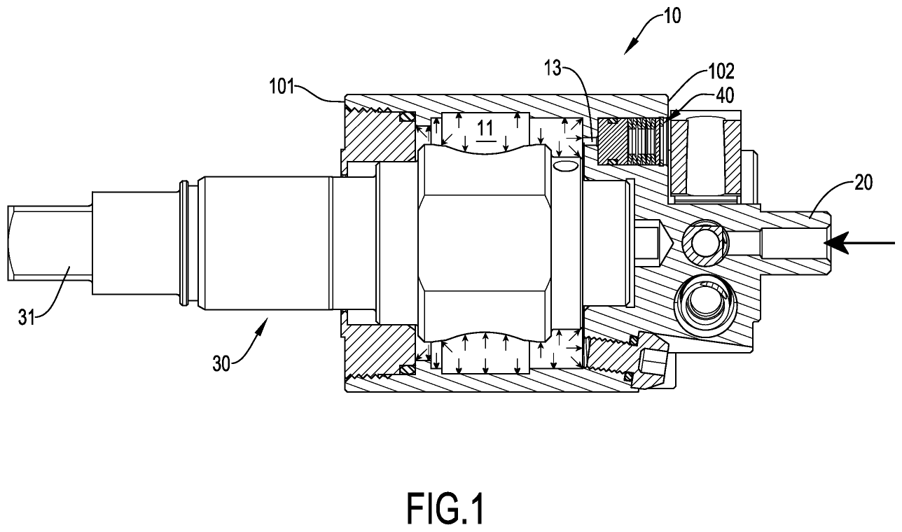

With reference to FIG. 1, an oil pulse unit of a pneumatic tool in accordance with the present invention comprises a cylinder 10, an input shaft 20, an output shaft 30, and a pressure-relief valve 40. The input shaft 20 is disposed on the cylinder 10. The output shaft 30 and the pressure-relief valve 40 are mounted with the cylinder 10.

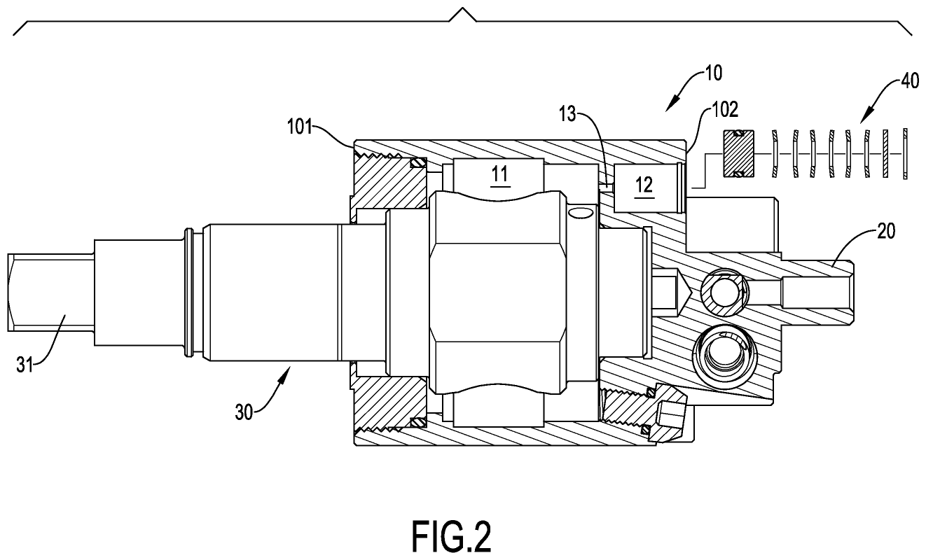

With reference to FIGS. 1 and 2, the cylinder 10 has an axial direction, a first end 101, a second end 102, a hydraulic oil chamber 11, a pressure-relief chamber 12, and a communicating channel 13. The first end 101 and the second end 102 are disposed oppositely on the cylinder 10 along the axial direction. The hydraulic oil chamber 11 is formed from the first end 101 of the cylinder 10 toward the second end 102 of the cylinder 10. The hydraulic oil chamber 11 is filled with hydraulic oil. The pressure-relief chamber 12 is formed from the second end 102 of the cylinder 10 toward the first end 101 of the cylinder 10. The pressure-relief chamber 12 does not communicate with the hydraulic oil chamber 11. The communicating channel 13 is formed in the cylinder 10 between the hydraulic oil chamber 11 and the pressure-relief chamber 12, and communicates with both the hydraulic oil chamber 11 and the pressure-relief chamber 12. Therefore, the pressure-relief chamber 12 communicates with the hydraulic oil chamber 11 via the communicating channel 13.

With reference to FIG. 1, the input shaft 20 is coaxially and integrally formed at the second end 102 of the cylinder 10. The input shaft 20 extends along the axial direction of the cylinder 10 and has a free end. The free end of the input shaft 20 is mounted with a rotor. Driven by high-pressure air, the rotor can propel the input shaft 20 to rotate. The structure of the rotor is a prior art, so the present invention does not describe the rotor in detail.

With reference to FIG. 1, the output shaft 30 is coaxially mounted with the cylinder 10 and extends into the hydraulic oil chamber 11. The output shaft 30 has a working end 31 extending out of the first end 101 of the cylinder 10. The working end 31 of the output shaft 30 can fasten or loosen fixing elements such as a bolt or a nut by making the fixing elements rotate.

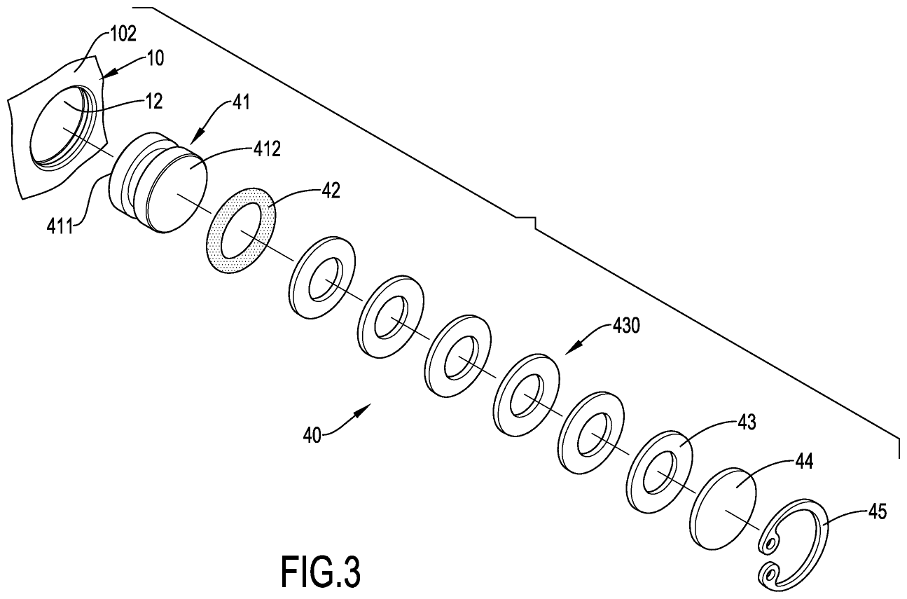

With reference to FIGS. 1 to 3, the pressure-relief valve 40 is mounted in the pressure-relief chamber 12 of the cylinder 10 and has a piston 41, a seal ring 42, an elastic element 430, a washer 44, and a retaining ring 45. The piston 41 has a first end 411 and a second end 412, and the second end 412 is opposite the first end 411 of the piston 41. The first end 411 of the piston 41 faces the communicating channel 13 of the cylinder 10. The seal ring 42 is sleeved on the piston 41 and abuts against an outer surface of the piston 41 and an inner surface of the pressure-relief chamber 12. The elastic element 430 has a first end 4301 and a second end 4302, and the second end 4302 is opposite the first end 4301 of the elastic element 430. The first end 4301 of the elastic element 430 abuts against the second end 412 of the piston 41. The elastic element 430 may be any element that has elasticity such as a compression spring. In the present invention, the elastic element 430 comprises multiple disc springs 43. The multiple disc springs 43 are disposed in the pressure-relief chamber 12, and the multiple disc springs 43 abut against the second end 412 of the piston 41. Because the pressure-relief chamber 12 is narrow, the multiple disc springs 43 are compressed with each other. Being compressed, the multiple disc springs 43 provide an elastic force that can bear the pressure exerted by the hydraulic oil. The number of the disc springs 43 can be changed according to the value of the pressure exerted by the hydraulic oil. The washer 44 abuts against the multiple disc springs 43, and the washer 44 is disposed between the elastic element 430 and the retaining ring 45. The multiple disc springs 43 are disposed between the piston 41 and the washer 44. The retaining ring 45 is embedded in the pressure-relief chamber 12 and abuts against the multiple disc springs 43.

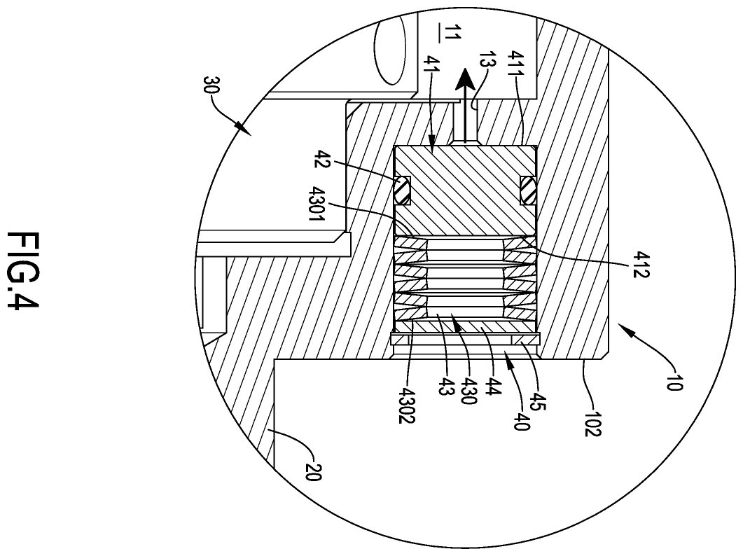

With reference to FIG. 1, the hydraulic oil exerts pressure on an inner surface of the hydraulic oil chamber 11. Flowing through the communicating channel 13, the hydraulic oil also exerts pressure on the piston 41. With reference to FIG. 4, when the pressure exerted by the hydraulic oil on the piston 41 is smaller than the elastic force exerted by the multiple disc springs 43 on the piston 41, the piston 41 moves toward the first end 101 of the cylinder 10 and blocks an end at which the hydraulic oil chamber 11 communicates with the communicating channel 13.

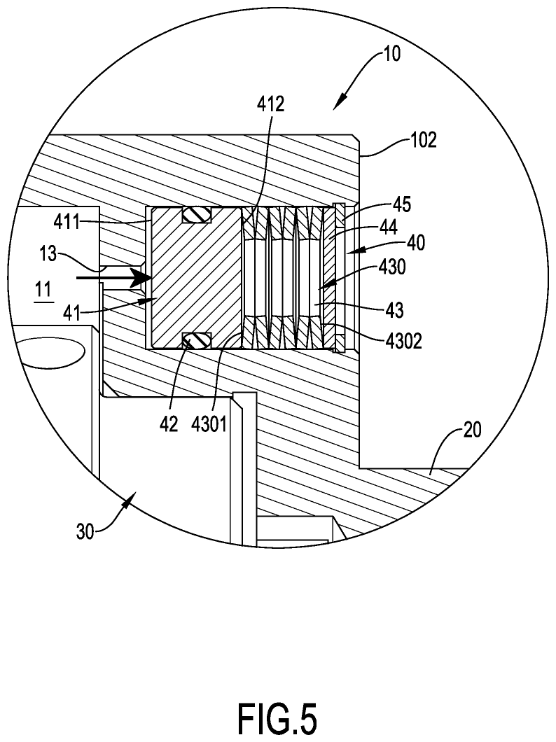

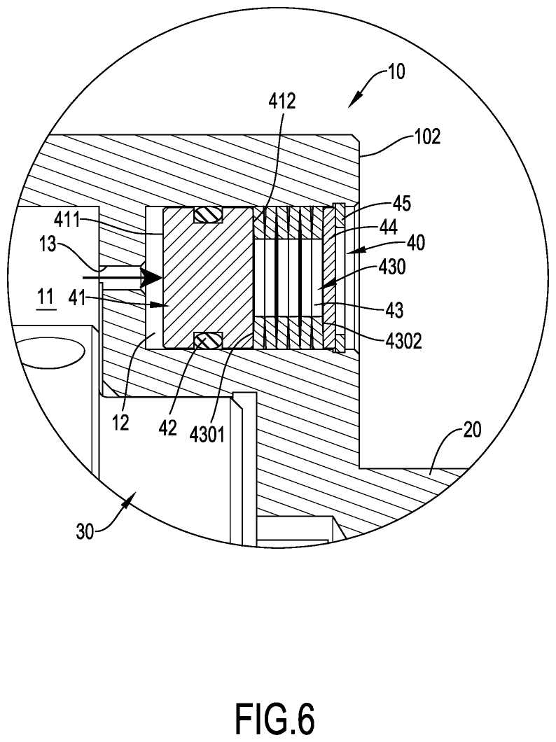

With reference to FIGS. 5 and 6, when the pneumatic tool comprising the oil pulse unit has worked for a long time, the temperature rises and the volume of the hydraulic oil increases. As the hydraulic oil is filled in the hydraulic oil chamber 11 with a fixed volume, the pressure of the hydraulic oil rises thereby. When the pressure exerted by the hydraulic oil on the piston 41 is bigger than the elastic force exerted by the multiple disc springs 43 on the piston 41, the piston 41 moves toward the second end 102 of the cylinder 10. In that case, the communicating channel 13 communicates with both the hydraulic oil chamber 11 and the pressure-relief chamber 12, which enables the hydraulic oil to flow from the hydraulic oil chamber 11 to the pressure-relief chamber 12. Compared with the space of the hydraulic oil chamber 11, part of the pressure-relief chamber 12 and the hydraulic oil chamber 11 together provide a bigger space for the hydraulic oil to flow within. The pressure of the hydraulic oil decreases due to the bigger space to flow within, so the oil pulse unit can keep working after a long-term use.

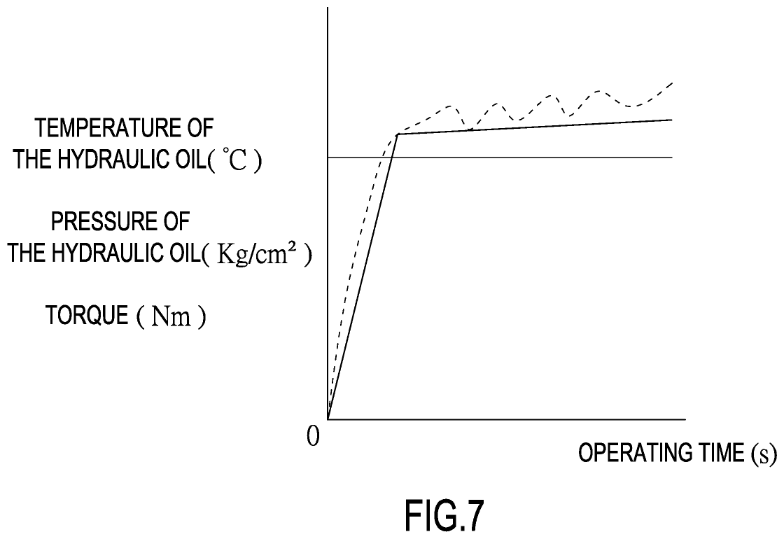

With reference to FIG. 7, the multiple disc springs 43 of the pressure-relief valve 40 can exert an elastic force on the piston 41. The thin horizontal line in FIG. 7 tells that the volume of the hydraulic oil chamber 11 is fixed. Bearing the pressure exerted by the hydraulic oil and the elastic force exerted by the multiple disc springs 43 from opposite directions, the piston 41 is movable within the pressure-relief chamber 12 of the cylinder 10. Because the space within which the hydraulic oil can flow is changeable as the pressure of the hydraulic oil increases or decreases, the torque outputted by the output shaft 30 is stable. The undulate line in FIG. 7 shows that the temperature and the pressure are adjustable as the piston 41 moves within the pressure-relief chamber 12 of the cylinder 10. The thick line as shown in FIG. 7 tells that the torque outputted by the output shaft 30 is still stable after a long term use. Furthermore, because the multiple disc springs 43 can bear heavy loads in the limited space of the pressure-relief chamber 12, the multiple disc springs 43 can provide enough elastic force to adjust the pressure exerted by the hydraulic force.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An oil pulse unit of a pneumatic tool comprising:
a cylinder having
a first end;
a second end being opposite the first end of the cylinder;
a hydraulic oil chamber formed from the first end of the cylinder toward the second end of the cylinder;
a pressure-relief chamber formed from the second end of the cylinder toward the first end of the cylinder; and
a communicating channel formed in the cylinder between the hydraulic oil chamber and the pressure-relief chamber, and communicating with the hydraulic oil chamber and the pressure-relief chamber;
an output shaft coaxially mounted with the cylinder, extending into the hydraulic oil chamber, and having a working end extending out of the first end of the cylinder; and
a pressure-relief valve mounted in the pressure-relief chamber of the cylinder and having
a piston having
a first end facing the communicating channel of the cylinder; and
a second end being opposite the first end of the piston;
a seal ring sleeved on the piston, and abutting against an outer surface of the piston and an inner surface of the pressure-relief chamber;
an elastic element having
a first end abutting against the second end of the piston; and
a second end being opposite the first end of the elastic element; and
a retaining ring embedded in the pressure-relief chamber and abutting against the elastic element.

2. The oil pulse unit as claimed in claim 1, wherein the pressure-relief valve has a washer abutting against the second end of the elastic element.

3. The oil pulse unit as claimed in claim 2, wherein the elastic element comprises multiple disc springs.

4. The oil pulse unit as claimed in claim 1, wherein the elastic element is a compression spring.

5. The oil pulse unit as claimed in claim 2, wherein the elastic element is a compression spring.
